(19) United States
(12) Patent Application Publication
(10) Pub. No.: US 2024/0175553 A1
(43) Pub. Date: May 30, 2024

(54) NOZZLE FOR HIGH-PRESSURE CYLINDERS

(71) Applicant: CARBON CYLINDER S.R.L., Mira (Venezia) (IT)

(72) Inventor: Giovanni ARTUSI, Mira (Venezia) (IT)

(21) Appl. No.: 18/551,242

(22) PCT Filed: Mar. 24, 2022
(86) PCT No.: PCT/EP2022/057817

§ 371 Date: Sep. 19, 2023

(30) Foreign Application Priority Data
Apr. 12, 2021 (IT) 102021000009098

(51) Int. Cl. F17C 13/04

(52) U.S. Cl. CPC F17C 13/04

(57) ABSTRACT

Nozzle for cylinders containing a high-pressure fluid, including: a lower body designed to be applied stably to the mouth of the cylinder; an intermediate component, housed rotatably in a seat of the lower body and designed to accommodate an accessory, such as a fluid dispensing tap, a valve, or other; and an upper ring nut element designed to engage with the lower body to lock stably in position the intermediate component, with the accessory oriented in the required direction with respect to the cylinder.

The present invention relates to a nozzle for cylinders, in particular for containing fluids (liquid or aeriform) at high pressure, provided with a tap or valve for dispensing the fluid.

Various types of high-pressure cylinders are known, obtained from an inner liner in metal or plastic material, on which a nozzle in metal material is attached, normally provided with a thread suitable for tightening a tap or a seal valve. The liner is then covered with one or more layers of reinforcing threads.

In the case of cylindrical cylinders with a circular cross section, the application of the nozzle does not create any problems, since the accessory it carries (tap, valve, etc.), oriented transversely to the axis of the cylinder, is always correctly oriented, thanks to the axial symmetry of the cylinder.

However, in the case of cylinders with a non-circular section, by way of a non-limiting example square or rectangular, which are currently becoming increasingly common, the end of the screwing stroke of the nozzle on the cylinder, or on the nozzle, can lead to incorrect directionality of the accessory.

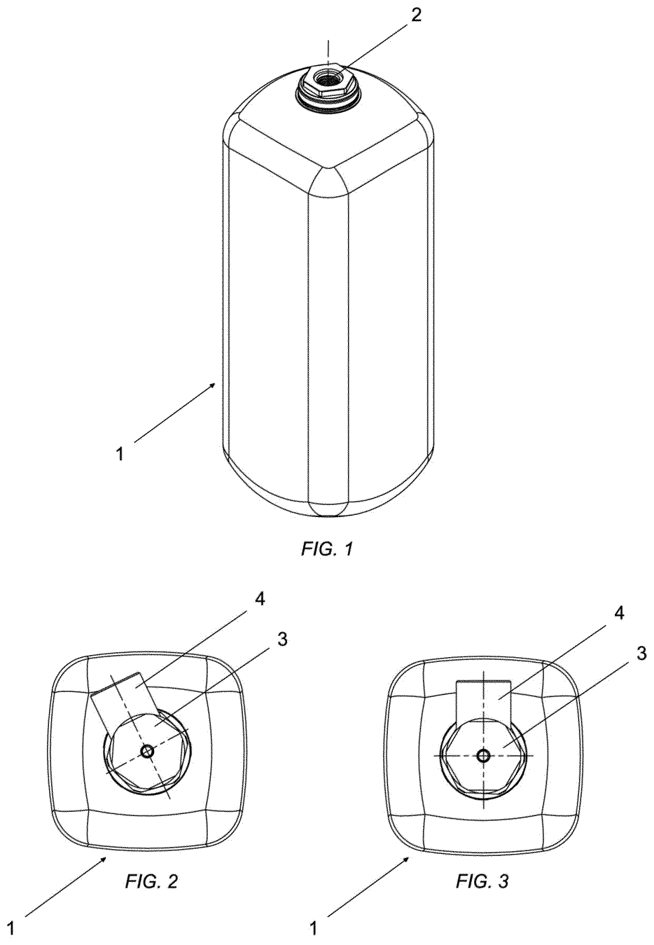

The accompanying FIG. 1 shows schematically in axonometry a square section cylinder 1, having an internally threaded mouth 2 for screwing in an accessory. FIG. 2 is a plan view from above of the cylinder, with an accessory 3 mounted, such as, for example, a valve or a fluid dispensing tap according to the prior art, with the outlet orifice 4, not correctly oriented, while FIG. 3 is a view like that of FIG. 2, showing how the accessory 3 and the relative orifice 4 should be correctly oriented, along a median plane of two opposing faces of the cylinder, to facilitate handling thereof.

FR 3095848 A1 discloses a pressurised gas reservoir head assembly, comprising a structure having an opening and a head comprising a base arranged in the opening and a valve assembled with the base, wherein the base comprises a boss arranged outside the reservoir, at least one first pipe comprising an axial portion along the non-emerging axis connected to the inside of the reservoir, and at least one radial portion drilled radially into the boss until it reaches the axial portion, and wherein the valve has a substantially annular shape comprising a first bore corresponding to the boss in order to be able to be engaged on the boss and at least one second pipe, one end of which opens into the first bore axially in line with the at least one radial portion.

There is therefore the problem of providing a nozzle which can be mounted on a cylinder with a non-circular cross section, so as to ensure the required orientation of an accessory, in particular an accessory axially connected to the nozzle.

The object of the invention is precisely to achieve this objective.

More particularly, an object of the invention is to provide a nozzle structure or a structure which can be screwed to the nozzle itself, which allows the accessories to be given the correct directionality on each type of cylinder.

Another object of the invention is to provide such a nozzle which ensures an excellent seal to the fluid contained in the cylinder.

Yet another object of the invention is to provide such a nozzle which is easily assembled and disassembled, as well as simple and inexpensive to manufacture.

These and other objects of the invention are achieved by the nozzle according to the invention, which has the features of the appended independent claim 1.

Advantageous embodiments of the invention are disclosed by the dependent claims.

Substantially, the nozzle for cylinders containing a high-pressure fluid comprises: a lower body designed to be stably applied to the mouth of the cylinder; an intermediate component, rotatably housed in a seat of the lower body and apt to accommodate an accessory, such as a fluid dispensing tap, valve, or other; and an upper ring nut element apt to engage with said lower body to hold the intermediate component firmly in position, with said accessory oriented in the required direction with respect to the cylinder.

wherein said seat is provided internally to said lower body, and wherein the upper end section of the wall of said lower body has an internal thread with which an external thread of the upper ring nut element engages in order to hold the intermediate component in the required angular position.

Further features of the invention will be made clearer by the following detailed description, referred to its embodiments purely by way of non-limiting example, illustrated in the accompanying drawings, in which:

FIG. 1 is a schematic view in axonometry of a square-section high-pressure cylinder without the fluid dispensing nozzle:

FIG. 2 is a plan view from above of the cylinder of FIG. 1, with a nozzle mounted according to the prior art, in which a fluid dispensing tap is not correctly oriented:

FIG. 3 is a view like that of FIG. 2, showing how the fluid dispensing tap should be correctly oriented:

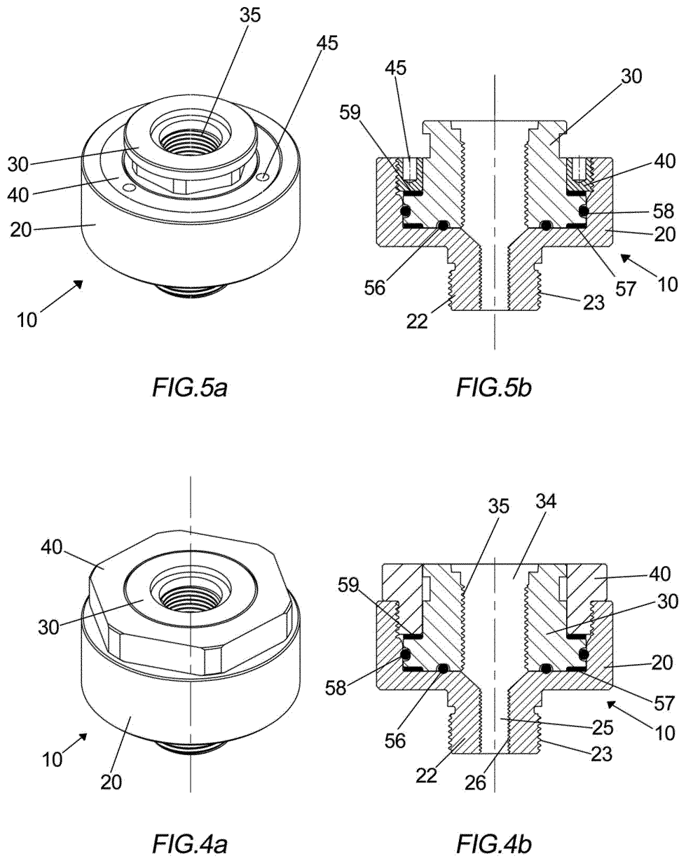

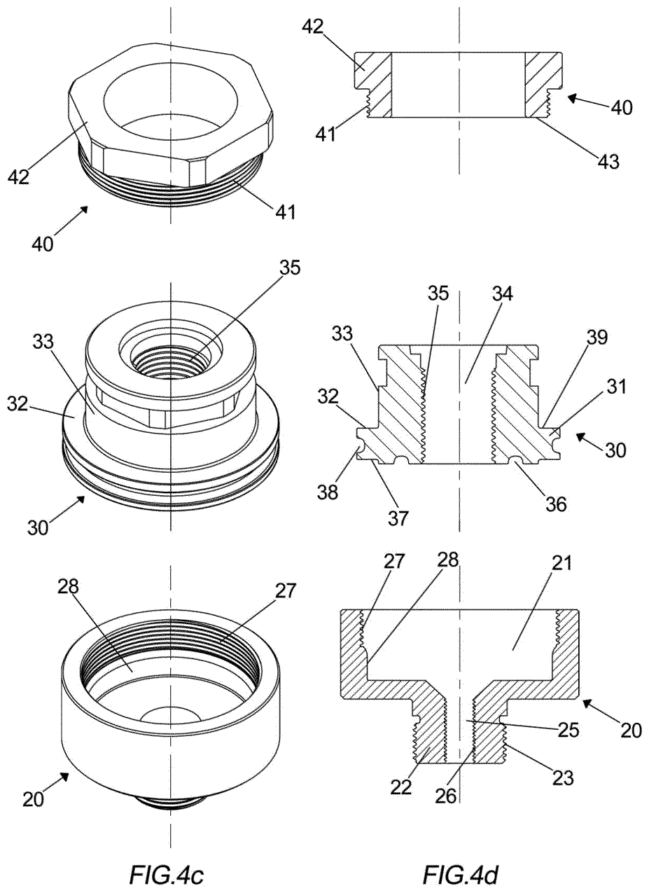

FIGS. 4a and 4b are overall views, respectively in axonometry from above and in median section, of a nozzle according to a first embodiment of the invention:

FIGS. 4c and 4d are blown-up views of FIGS. 4a and 4b, respectively:

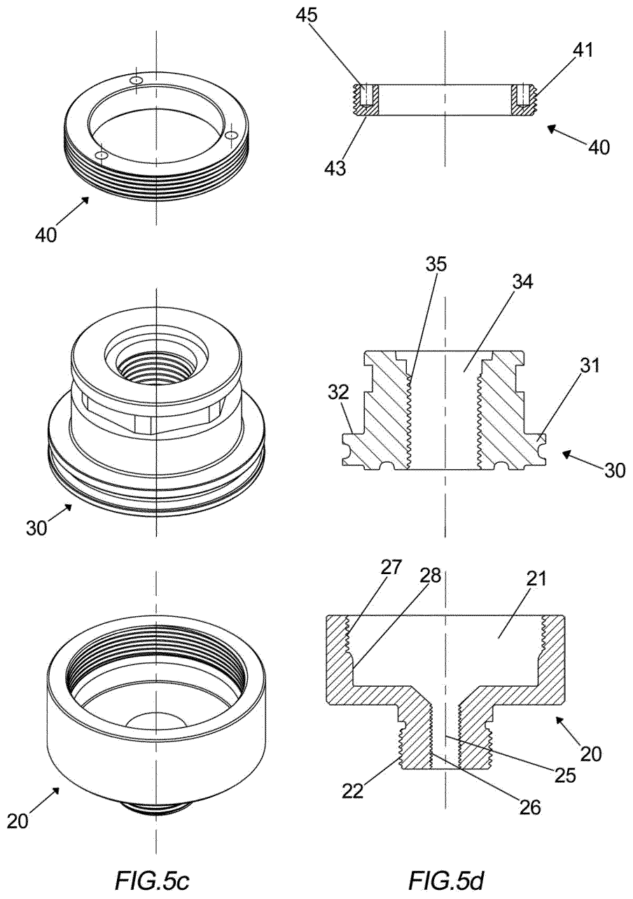

FIGS. 5a and 5b are overall views, respectively in axonometry from above and in median section, of a nozzle according to a second embodiment of the invention:

FIGS. 5c and 5d are blown-up views of FIGS. 5a and 5b, respectively:

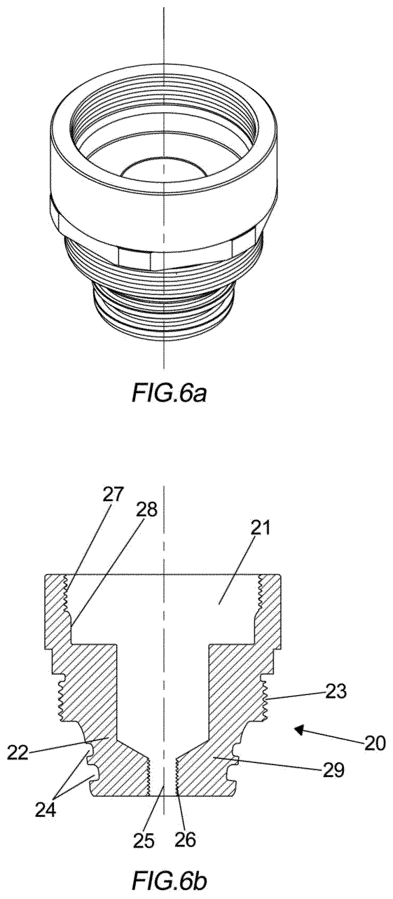

FIGS. 6a and 6b are, respectively, an axonometric view from above and a median section view of a different embodiment of the lower body of the nozzle of the preceding drawings.

Referring to FIGS. 4a-d, the nozzle according to the invention, denoted overall by reference numeral 10, comprises a lower body 20, a central or intermediate component 30 and an upper element 40.

The lower body 20 has a cup shape with a cylindrical upper seat 21 suitable for housing the intermediate component 30 and a shank 22 projecting below bearing an external thread 23 suitable for screwing in, for example, with the internal thread of the mouth 2 of the container 1 of FIG. 1, remaining stably fixed with respect thereto.

The shank 22 has an axial hole 25 for the passage of the fluid, which in this case has a thread 26 for mounting an accessory, such as for example an EFV (Excess Flow Valve).

The upper end section of the wall of the body 20 has an internal thread 27 with which the external thread 41 of the upper element 40 engages in order to lock the intermediate component 30 in the required angular position.

In fact, the component 30 is housed freely rotatably in the seat 21 of the body 20 and has a widened base 31 extending for a height substantially corresponding to the unthreaded lower section 28 of the wall of the body 20, so as to determine a step or shoulder 32 in the area of joining with the upper section of smaller diameter 33 of the component 30.

The upper element 40 is substantially a locking ring nut also having a play recovery function, having a hexagonal head 42, for the engaging of a tightening key, which abuts against the upper edge of the wall of the body 20, while the lower edge 43 of its wall with external thread 41 abuts against the shoulder 32 of the intermediate component 30, in order to lock it securely in position.

The intermediate component 30, which has an axial through hole 34, has an internal thread 35 with which an interchangeable axial accessory, for example the fluid dispensing accessory 3 shown in FIG. 3, goes to be screwed.

The nozzle structure according to the invention, thanks to the arrangement of the component 30 in the body 20 with possibility of rotation before tightening with the ring nut 40, allows conferring of the correct directionality to the fluid dispensing accessory, on the basis of the geometric conformation of the cylinder on which it is applied.

Thus, for example, in the case of FIG. 3, the nozzle is locked into position in such a way that the accessory is oriented along a median plane of the square section cylinder.

The intermediate component 30 has a plurality of annular seats for sealing gaskets, in particular: a semi-circular seat 36 and a flat seat 37 arranged on its bottom wall, suitable for accommodating an O-ring type sealing ring 56 and a sealing gasket in metal/plastic material 57 which abuts against the bottom of the seat 21 of the body 20; a semi-circular seat 38 on the edge of the widening 31 suitable for accommodating a sealing ring 58 which abuts against the inner side wall of the body 20, and a flat seat 39 on the upper part of the widening 31, coinciding with the shoulder 32, suitable for accommodating a gasket in metal/plastic material 59 which abuts against the lower edge 43 of the upper ring nut element 40.

According to needs, the seats 36-39 can all be used to accommodate the respective gaskets 56-59, or according to various combinations, guaranteeing, in any cases, so that the seal is effective, the presence of at least two seats with the respective gaskets.

The embodiment of FIGS. 5a-5d is entirely similar to that of FIGS. 4a-4d, with the exception of the upper ring nut element 40 which is devoid of the hexagonal head 42, and is therefore more flattened, having above a series of holes 45 for engaging a suitable tightening key.

In this case, the ring nut element is placed flush with the upper edge of the body 20 (FIG. 5b).

FIGS. 6a and 6b show an alternative embodiment of the lower body 20 of the nozzle, which differs from the preceding ones in that a lower conical extension 29 is provided, in such a way that the nozzle 10 is shaped to be able to adapt to the high-pressure cylinders described in Italian patent applications No. 102021000003650 and No. 102021000006806, which have not yet been published. One or more seats for sealing gaskets 24 are provided on this extension 29.

It is however evident that the body 20, like also the intermediate component 30 and the upper ring nut element 40, can be variously shaped, provided that the component 30 is housed with the possibility of rotation in the body 20 where it is blocked by the ring nut element 40.

From what has been disclosed, the advantages of the nozzle for high-pressure cylinders according to the invention appear clear, which allows the right directionality to be given to the interchangeable elements which it can mount, such as, in particular, a tap, a valve or the like, on the basis of the geometry of the cylinder on which it is applied.

Naturally the invention is not limited to the particular embodiment previously described and illustrated in the accompanying drawings, but numerous detailed changes may be made thereto within the reach of the person skilled in the art, without thereby departing from the scope of the invention itself, as defined in the following claims.

1. Nozzle for cylinders containing a high-pressure fluid, comprising:
a lower body adapted to be applied stably to a mouth of a cylinder;
an intermediate component rotatably housed in a seat of the lower body, said intermediate component having an axial through hole and an internal thread for screwing connection of an interchangeable axial fluid dispensing accessory; and
an upper ring nut element apt to engage with said lower body to hold the intermediate component stably in position, with said fluid dispensing accessory oriented in the required direction with respect to the cylinder, wherein said seat is provided internally to the lower body and wherein the upper end section of the wall of said lower body has an internal thread with which an external thread of the upper ring nut element engages to maintain the intermediate component in the required angular position.

2. Nozzle according to claim 1, wherein said lower body has below a shank provided with an external thread suitable for engaging with an internal thread of said mouth of the cylinder.

3. Nozzle according to claim 1, wherein said intermediate element has a widened base connected to an upper section of smaller diameter with a step or shoulder against which the lower edge of the ring nut element abuts.

4. Nozzle according to claim 1, wherein said intermediate component has a plurality of annular seats, at least one or more of which are apt to accommodate respective sealing gaskets.

5. Nozzle according to claim 2, wherein said shank has a second internal thread for the mounting of an accessory, such as an EFV (Excess Flow Valve).

6. Nozzle according to claim 1, wherein said ring nut element has a polygonal head, for the engagement of a tightening key, which abuts on the upper edge of the wall of the body.

7. Nozzle according to claim 1, wherein said ring nut element has above a series of holes for the engagement of a suitable tightening key, and has a thickness such as to be arranged flush with the upper edge of the body.

8. Nozzle according to claim 1, wherein said lower body has a lower conical extension.

9. Nozzle according to claim 1, wherein it is applied to a cylinder with non-circular section, such as square, rectangular, or the like.
